(19) United States
(12) Patent Application Publication
(10) Pub. No.: US 2025/0265175 A1
(43) Pub. Date: Aug. 21, 2025

(54) TEST APPARATUS, TEST METHOD AND PROGRAM

(71) Applicant: NIPPON TELEGRAPH AND TELEPHONE CORPORATION, Tokyo (JP)

(72) Inventors: Masaki TAJIMA, Tokyo (JP); Hiroyuki KIRINUKI, Tokyo (JP); Haruto TANNO, Tokyo (JP); Takahiro KAWAGUCHI, Tokyo (JP); Takako KAWAGUCHI, Tokyo (JP)

(21) Appl. No.: 18/703,031

(22) PCT Filed: Oct. 22, 2021
(86) PCT No.: PCT/JP2021/039131

§ 371 Date: Apr. 19, 2024

(51) Int. Cl. G06F 11/3668

(52) U.S. Cl. CPC G06F 11/3672

(57) ABSTRACT

A test apparatus includes circuitry configured to acquire log information according to a first user operation; generate, for each screen of a target page of a software test, a page object defining one or more methods, based on the log information, each of the methods indicating a test procedure and a second user operation for an operation target that is to be performed on the screen of the target page; generate, based on the methods defined by the page object, a manual of the software test, the manual including (i) operation content information indicating a content of the second user operation, (ii) the test procedure, and (iii) an image indicating the screen of the target page, the image being used for identifying the operation target as the second user operation; and output data of the manual.

### TECHNICAL FIELD

The present disclosure relates to a test apparatus, a test method, and a program.

### BACKGROUND ART

In recent years, demands for releasing software early while reducing cost have increased. Therefore, it can be said that a software test that accounts for a large proportion of cost of entire development and is required to ensure certain quality of software is essential for quality, cost, and delivery (QCD) in development.

As techniques for automating a software test involving a screen operation of an application such as a web application or a mobile application that has a screen, there are mainly two types of “record & replay” and “programming”. “Record & replay” is a technique for reproducing a user operation by recording the user operation as a script, as it is, and executing the script. On the other hand, “programming” is a technique for describing a test code for which a library for operating a browser is used as a program, and executing a test using the test code.

In the related art, as a technique for making a software test dramatically more efficient, a technique for inputting an operation log of a user and generating a test script has been proposed (see Non Patent Literature 1). According to this technique, the software test can be automatically executed by executing the generated test script.

### CITATION LIST

### Non Patent Literature

Non Patent Literature 1: Business Communication 2021 Vol. 58 No. 2 Tansaku-teki tesuto shigen gijutsu ˜LatteArt no go shokai˜ (Exploratory Test Resource Technology ˜Introduction of LatteArt˜) <https://www.bcm.co.jp/site/2021/02/sic/2102-sic-01-07.pdf>

### SUMMARY OF INVENTION

### Technical Problem

However, when the user grasps test content of the generated test script, there is the following problem. As a premise, an operation executed in the software test includes text input to a form (input) on the screen, a selection operation of a radio button, a check box, and the like, and screen transition by clicking a link button.

A name (an identifier of the element) for identifying a screen element (a form, a button, a link, or the like) which is an operation target is automatically named based on an attribute value (id, name, text, etc.) on a source code (HTML or the like) on the screen. Therefore, which element is indicated on an actual test screen may not be clear and is not explanatory.

In order for a user to understand a procedure of an entire software test involving the screen transition, it is necessary to actually execute the software test and visually follow the operation in sequence or visually follow a character string of a test script in sequence, which is not easy.

The present invention has been devised in view of the foregoing circumstances, and an object of the present invention is to enable a user to more easily grasp execution content of a software test as compared with the related art.

### Solution to Problem

In order to solve the above problem, an invention according to claim 1 is a test apparatus that executes a software test. The test apparatus includes: log information acquisition means for acquiring log information according to an operation of a user; first generation means for generating, for each screen of a target page of the software test, a page object defining methods indicating a test procedure and a user operation for an operation target on the screen of the target page based on the log information; second generation means for generating a manual of the software test including operation content information indicating content of the operation of the user, the test procedure, and an image indicating a screen of the target page for identifying an operation target of the operation of the user based on the methods of the page object; and output means for outputting data of the manual.

### Advantageous Effects of Invention

As described above, according to the present invention, it is possible to obtain an advantageous effect that a user can more easily grasp execution content of a software test as compared with the related art.

### BRIEF DESCRIPTION OF DRAWINGS

FIG. 1 is a diagram illustrating a hardware configuration of a test device according to an embodiment of the present invention.

FIG. 2 is a diagram illustrating a functional configuration of the test device according to the embodiment of the present invention.

FIG. 3 is a flowchart illustrating an overall process executed by the test device.

FIG. 4 is a flowchart illustrating a detailed process of a test script generation method.

FIG. 5 is a diagram illustrating a concept of a test script as a premise for executing a process of the embodiment.

FIG. 6 is a flowchart illustrating a detailed process of a method of generating a test script manual.

FIG. 7 is a diagram illustrating a concept of a screen transition diagram of each test case generated for the test script (test case) of FIG. 5.

FIG. 8 is a diagram illustrating a concept of a screen transition diagram for overlooking all the test cases generated for the test script (test case) of FIG. 5.

FIG. 9 is a diagram illustrating a concept of a screen transition diagram generated for the test script (page object) of FIG. 5.

FIG. 10 is a diagram illustrating a concept of information indicating a test procedure with an image (screenshot image) of a screen element operated with a page object p₁.

FIG. 11 is a diagram illustrating a concept of information indicating a test procedure with an image (screenshot image) of a screen element operated in a page object p₂.

FIG. 12 is a diagram illustrating a concept of information indicating a test procedure with an image (screenshot image) of a screen element operated in a page object p₃.

### DESCRIPTION OF EMBODIMENTS

Hereinafter, embodiments of the present invention will be described with reference to the drawings.

### Hardware Configuration

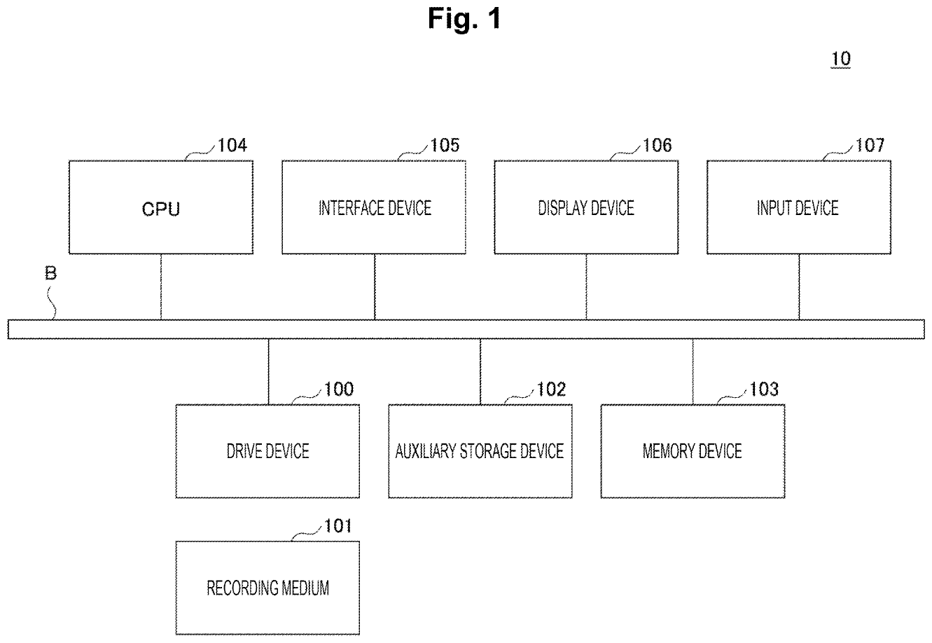

FIG. 1 is a diagram illustrating a hardware configuration of a test device according to an embodiment of the present invention. Hereinafter, a software test is simply referred to as a “test”.

A test device 10 is a device that generates a manual of a test script based on test log information and the test script generated from the log information.

As illustrated in FIG. 1, the test device 10 is implemented by a personal computer (PC) or the like, and includes a drive device 100, an auxiliary storage device 102, a memory device 103, a CPU 104, an interface device 105, a display device 106, and an input device 107 which are connected to each other by a bus B.

A program implementing a process in the test device 10 is provided by a recording medium 101 such as a CD-ROM. When the recording medium 101 storing the program is set in the drive device 100, the program is installed on the auxiliary storage device 102 from the recording medium 101 via the drive device 100. Here, the program is not necessarily installed from the recording medium 101 and may be downloaded from another computer via a network. The auxiliary storage device 102 stores the installed program and also stores required files, data, and the like.

When an instruction to start the program is received, the memory device 103 reads and stores the program from the auxiliary storage device 102. The CPU 104 implements a function related to the test device 10 in accordance with a program stored in the memory device 103. The interface device 105 is used as an interface for connection with a communication network such as the Internet. The display device 106 displays a graphical user interface (GUI) and the like in accordance with the program. The input device 107 is configured with a keyboard and a mouse, for example, and is used to input various operation instructions. A mobile terminal or the like may be used as the test device 10.

### Functional Configuration

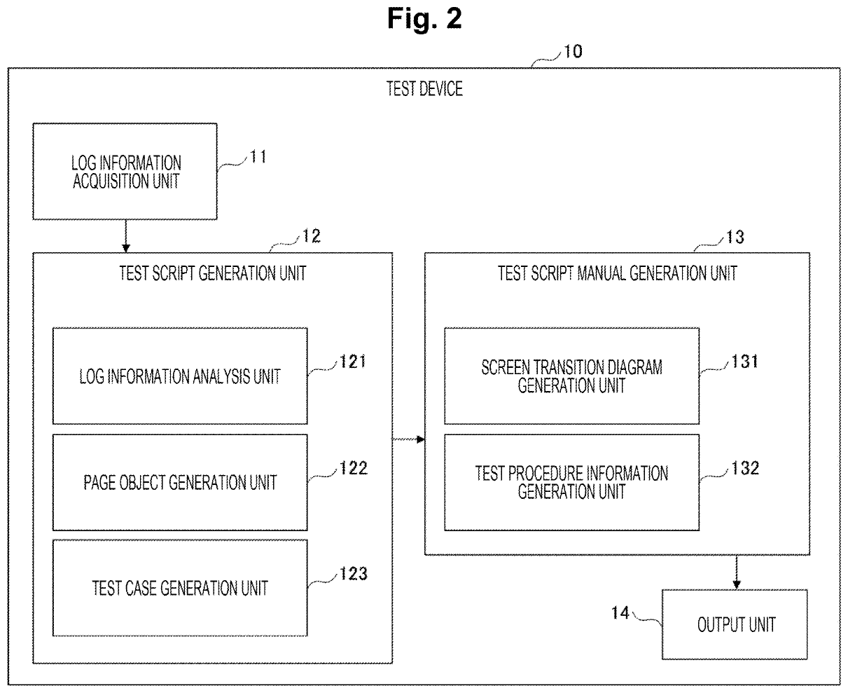

FIG. 2 is a diagram illustrating a functional configuration of the test device according to the embodiment of the present invention. The test device 10 includes a log information acquisition unit 11, a test script generation unit 12, a test script manual generation unit, and an output unit 14. These units are implemented through a process executed by the CPU 104 in accordance with one or more programs installed in the test device 10.

Of these units, the log information acquisition unit 11 acquires log information through a user operation during the test. The test log information includes an operation performed by the user during the test, a screen element (a form, a button, a link, or the like) to be operated, information regarding transition of a screen of a test target page, and an image indicating the screen of the test target page.

The test script generation unit 12 generates a test script. The test script includes a page object and a test case using the page object. The “page object” is information defining methods indicating a test procedure and a user operation for the target page on an operation target on the screen for each screen of the test target page. Specifically, the page object is an object indicating a screen element (a form, a button, a link, or the like) which is an operation target on the screen of the target page and a procedure (1st, 2nd, 3rd, and the like) of the user operation (input, selection, click, etc.) on the screen element in association so that the screen element can be more easily used in the program, and one is generated for each test target page. The “test case” is information indicating a route (path) to a termination target page by screen transition using a predetermined target page as a starting point by each method defined by a plurality of page objects and indicating one unit of a test. That is, the test case is information indicating a series of test procedures or the like defined by combining user operations defined by a plurality of page objects. One test script includes one or more test cases.

The test script generation unit 12 includes a test log information analysis unit 121, a page object generation unit 122, and a test case generation unit 123 in order to generate a test script. The test script generation unit 12 is an example of first generation means. The test script manual generation unit is an example of second generation means.

Of these units, the log information analysis unit 121 analyzes the log information acquired by the log information acquisition unit 11. The page object generation unit 122 generates the above-described page object. The test case generation unit 123 generates the above-described test case.

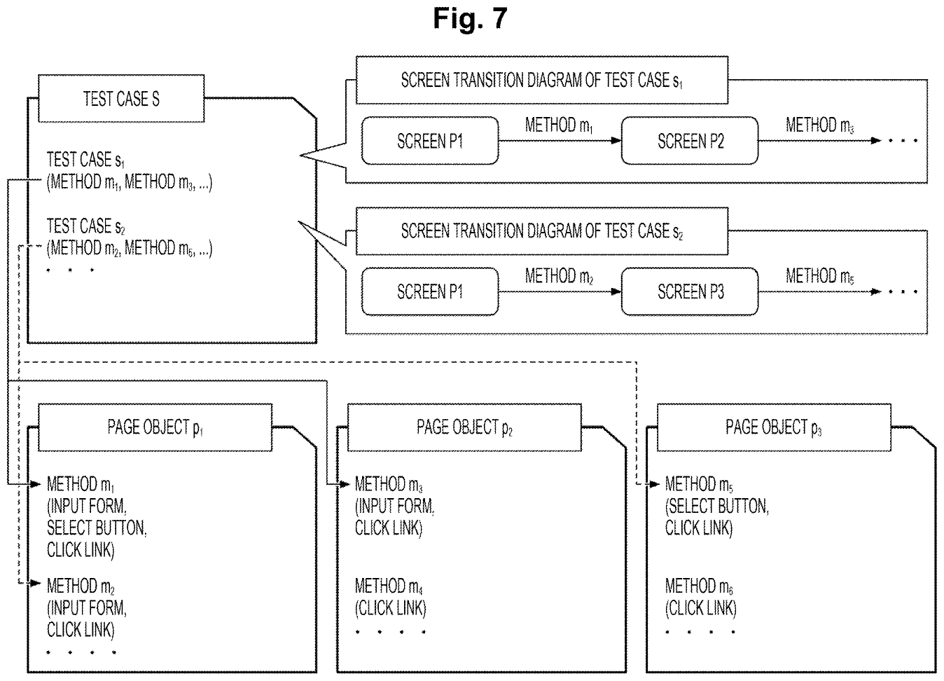

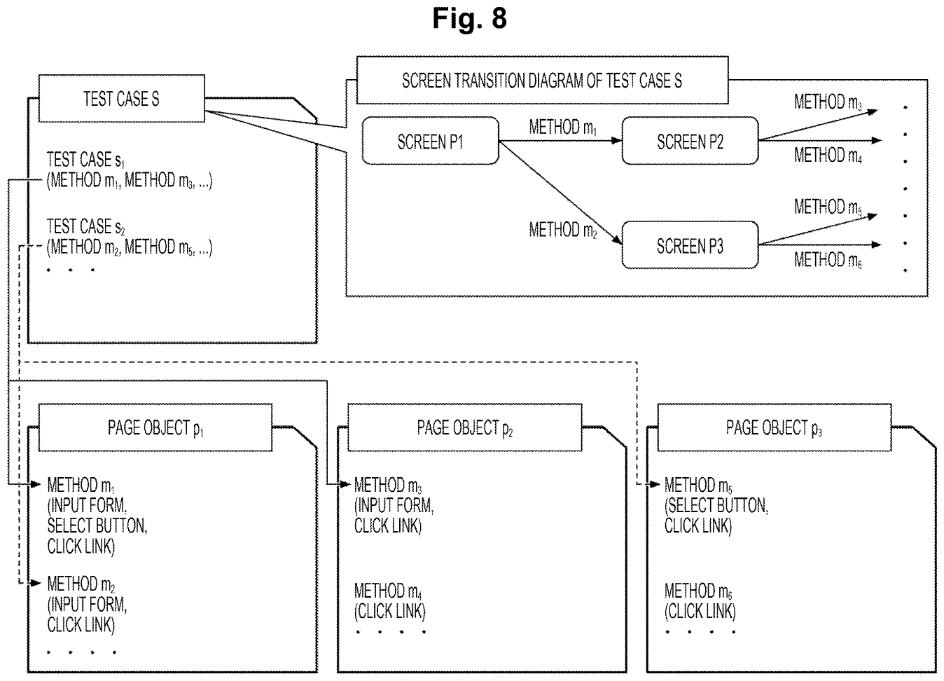

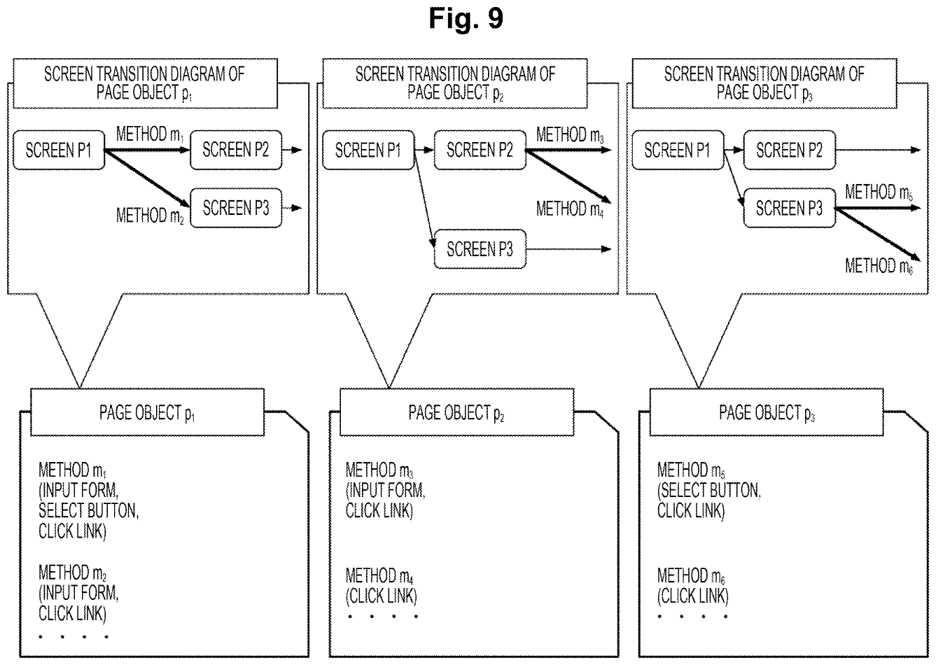

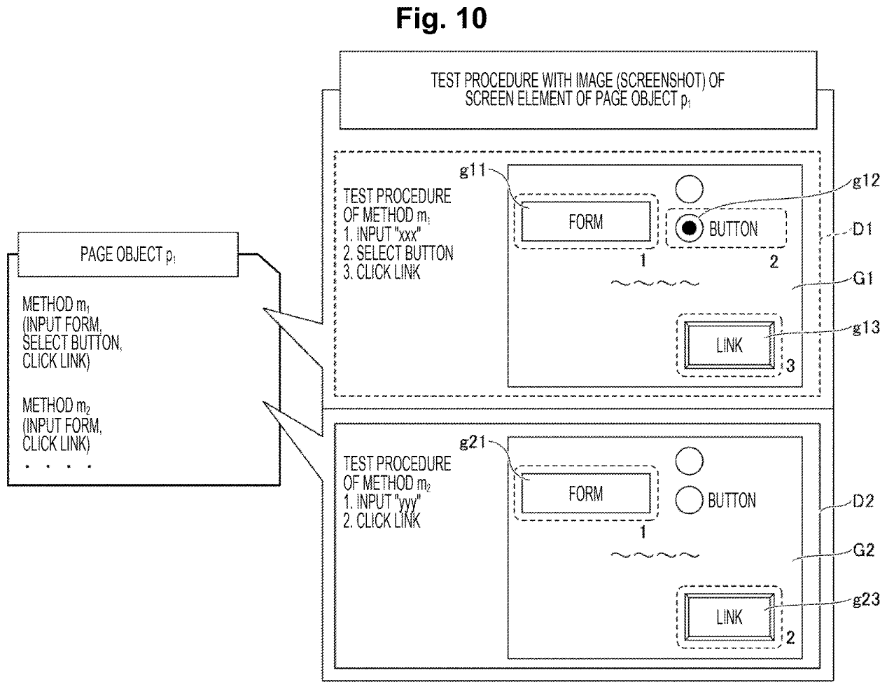

Next, the test script manual generation unit 13 generates a manual of the test script. The manual of the test script is handled as the manual of the test so that the user can more easily visually grasp the test script in the end. The manual of the test script includes a screen transition diagram of each test case (see FIG. 7), a screen transition diagram for overlooking all the test cases (see FIG. 8), a screen transition diagram illustrating a screen transition operated on the page object (see FIG. 9), and information indicating a test procedure with an image (screenshot image) of a screen element operated on the page object (see FIGS. 10 to 12).

The test script manual generation unit 13 includes a screen transition diagram generation unit 131 and a test procedure information generation unit 132 in order to generate a manual of the test script.

Of these units, the screen transition diagram generation unit 131 generates a screen transition diagram of each test case (see FIG. 7), a screen transition diagram of overlooking all the test cases (see FIG. 8), and a screen transition diagram illustrating a screen transition operated on a page object (see FIG. 9). The test procedure information generation unit 132 generates information (see FIG. 10) indicating a test procedure with an image (screenshot) of a screen element operated in the page object.

Next, the output unit 14 outputs data of the manual generated by the test script manual generation unit 13. Examples of the output method include display of data of the manual on the display device 106 and transmission of the data of the manual from the interface device 105 to another device via a communication network.

### Process or Operation According to Embodiment

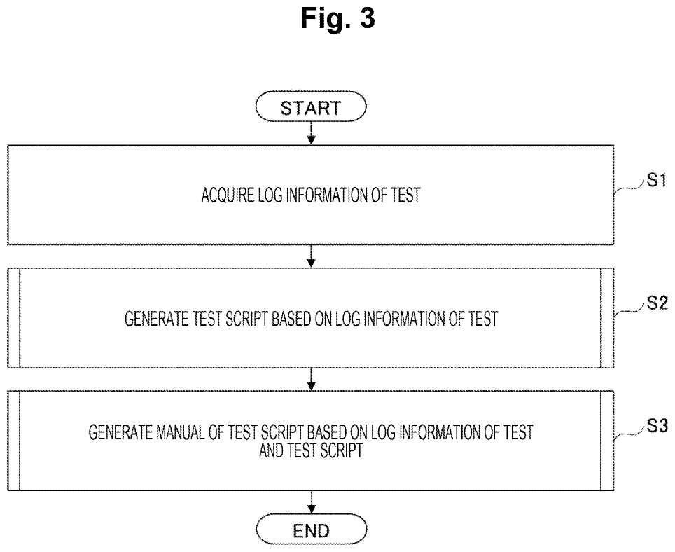

Next, a process or operation of the embodiment will be described in detail with reference to FIGS. 3 and 10. FIG. 3 is a flowchart illustrating an overall process executed by the test device.

As illustrated in FIG. 3, during the test, log information obtaining unit 11 obtains the above-described log information through the user operation (S1).

Subsequently, based on the log information acquired by the log information acquisition unit 11, the test script generation unit 12 generates a test script with high maintainability which is based on the page object and the test case using the page object (S2).

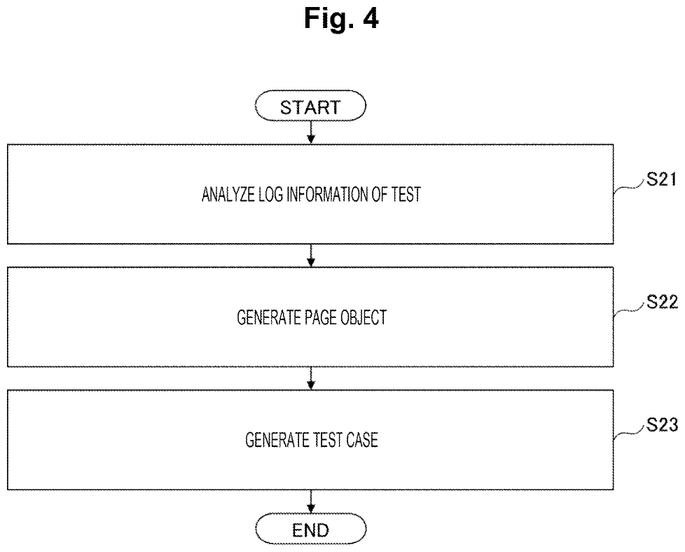

Here, step S2 will be described in detail with reference to FIG. 4. FIG. 4 is a flowchart illustrating a detailed process of a test script generation method.

As illustrated in FIG. 4, the log information analysis unit 121 analyzes the log information acquired by the log information acquisition unit 11 (S21).

Subsequently, the page object generation unit 122 generates a page object based on the log information analyzed by the log information analysis unit 121 (S22).

Subsequently, the test case generation unit 123 generates a test case by combining methods defined in each page object generated by the page object generation unit 122, and adds the test case to the test script (S23).

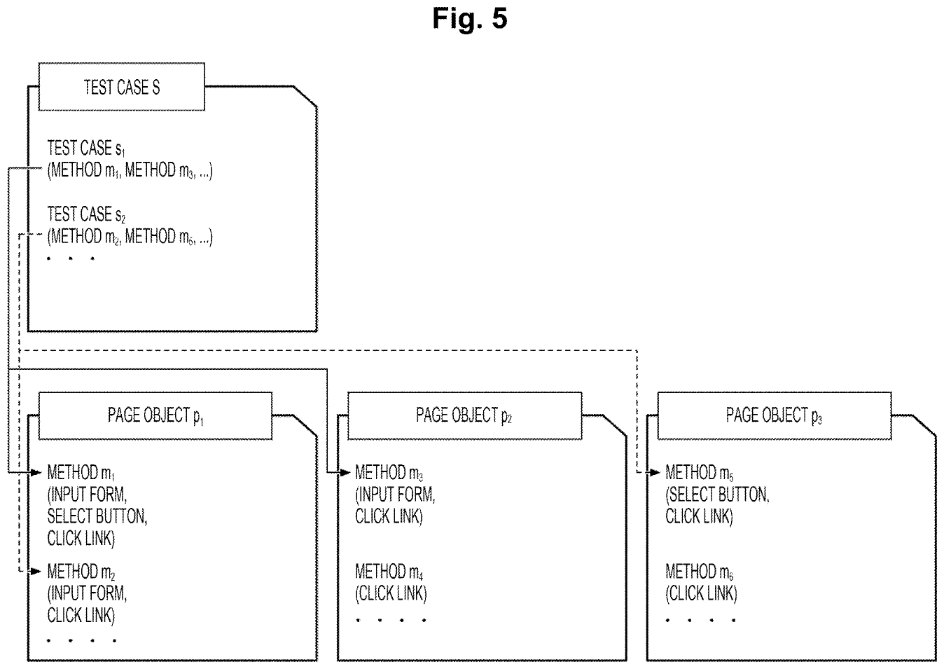

Next, referring back to FIG. 3, the test script manual generation unit 13 generates a manual of the test script based on the log information of the test and the test script. Here, step S3 will be described in detail with reference to FIGS. 5 to 12.

First, a test case and a page object included in a test script will be described as a premise of the process with reference to FIG. 5. FIG. 5 is a diagram illustrating a concept of a test script as a premise for executing the process according to the embodiment.

As illustrated in FIG. 5, the test script includes a set S of test cases and a set P of a plurality of page objects. Each page object pⱼ (ϵP) includes a set M of methods. Each method mₖ (ϵM) is a column of the user operation (a text input to a form, a selection of a radio button, a link click operation, or the like) on the operation target in the screen of the target page for each screen of the target page of the software test, and also indicates the test procedure. Each individual test case sᵢ(ϵS) is a column of methods.

### Generating Manual

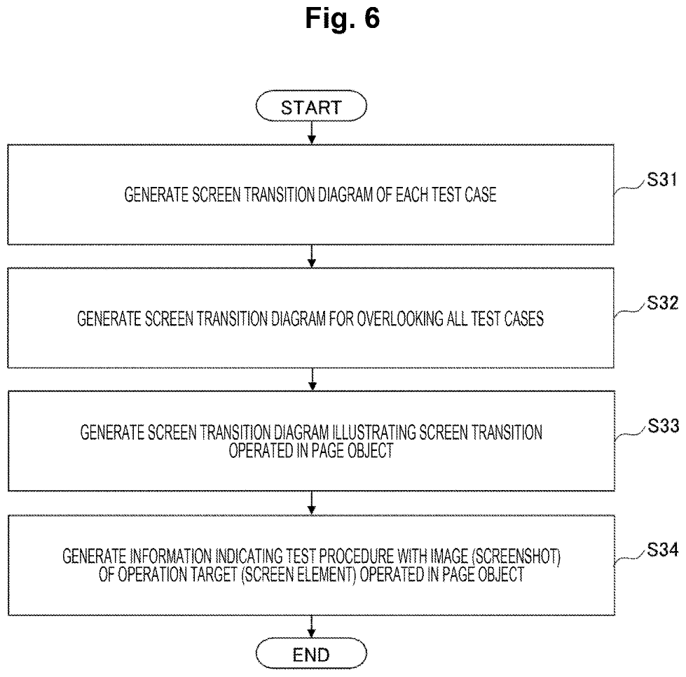

Next, each process of step S3 will be described in detail with reference to FIGS. 6 to 9 on the premise of the test script as illustrated in FIG. 5. FIG. 6 is a flowchart illustrating a detailed process of a method of generating a manual of a test script.

As illustrated in FIG. 7, the screen transition diagram generation unit 131 generates a screen transition diagram of each test case sᵢ based on the test case script (test case) (S31). FIG. 7 is a diagram illustrating a concept of a screen transition diagram of each test case generated for the test script (test case) of FIG. 5. In FIG. 7, each test case sᵢ is a column of the method mₖ. As illustrated in FIG. 7, for each test case sᵢ, the screen transition diagram generation unit 131 sequentially generates a screen transition diagram in the order of the method mₖ using a node of the screen transition diagram as a screen (that is, the page object pⱼ) and using an edge as a method mₖ.

For example, in FIG. 7, the screen transition diagram generated by the screen transition diagram generation unit 131 visually indicates that the screen P1 is generated in the test case s₁, the screen P2 is generated according to the method m₁ of the test case s₁, and the subsequent screen is generated according to the next method m₃ of the same test case s₁.

Next, as illustrated in FIG. 8, the screen transition diagram generation unit 131 generates a screen transition diagram for overlooking all the test cases s generated in step S31 (S32). FIG. 8 is a diagram illustrating a concept of a screen transition diagram for overlooking all the test cases generated for the test script (test case) of FIG. 5. Here, the screen transition diagram generation unit 131 integrates the screen transition diagrams of the test cases sᵢ generated in step S31 in order to support understanding of the test content by overlooking the screen transition of all the test cases in addition to the test cases sᵢ. In this case, the screen transition diagram generation unit 131 generates a screen in which overlapping nodes and edges among the plurality of screen transition diagrams generated in step S31 are combined into one.

For example, in FIG. 8, in the screen transition diagram generated by the screen transition diagram generation unit 131, in all the test cases S, it is visually indicated that the screen P1 is the root of a tree structure, the screen P2 that is a node is generated through the edge that is the method m₁ of the test case s₁, and the screen P3 that is a node is generated through the edge that is the method m₂ of the test case s₂ in a layer lowered by one level from the hierarchy. Further, it is visually indicated that the screens P2 and P3 are set as nodes of the tree structure, and the screens are similarly generated in a layer further lowered by one level from the hierarchy.

Next, as illustrated in FIG. 9, the screen transition diagram generation unit 131 generates a screen transition diagram illustrating screen transition operated in each page object (S33). FIG. 9 is a diagram illustrating a concept of a screen transition diagram generated for the test script (page object) of FIG. 5. Here, the screen transition diagram generation unit 131 highlights the method mₖ (that is, the edge in the screen transition diagram) of the page object pⱼ in the screen transition diagram generated in step S32 in FIG. 8 (a thick line displayed in FIG. 9) in order to support understanding of the user operation indicating what kind of screen transition is executed in each page object pⱼ.

Next, as illustrated in FIG. 10, the test procedure information generation unit 132 generates data of a manual indicating a test procedure with an image (screenshot image) of a screen element operated in each page object using the screen generated by combination in step S32 (S34). FIG. 10 is a diagram illustrating a concept of information indicating a test procedure with an image (screenshot image) of a screen element operated in the page object p₁. Here, the test procedure information generation unit 132 uses the image (screenshot image) of the screen element included in the test log information. In the test log information, the method mₖ and the image (screenshot image) of the screen element are associated with each other by a known technique. Based on the order of the method mₖ in each page object pⱼ, information indicating a test procedure is generated using an image of a screen element (screenshot image).

### Display of Screen

Next, the information generated in step S34 will be described with reference to FIGS. 10 to 12. FIG. 10 is a diagram illustrating a concept of information indicating a test procedure with an image (screenshot image) of a screen element operated in the page object p₁.

As illustrated in FIG. 10, when the test procedure of the method m₁ is displayed on the display device 106, the test procedure of the method m₁ is illustrated on the left side of the screen D1. An image (screenshot image) G1 of a screen element is illustrated on the right side of the screen D1. In the image G1, a (input) form g11, a radio button g12, a link button g13, and the like are illustrated. Here, when the user selects any step of the test procedure using a mouse or the like, an enclosure and the order of the procedure are displayed at a corresponding position on the image G1. For example, in FIG. 10, when the user selects the operation content information “1. Input “xxx””, an enclosure line (an enclosure line by a broken line in FIG. 10) is displayed in the form g11 corresponding thereto, and “1” is also displayed as the test procedure in the method mi near the enclosure line.

On the other hand, as illustrated in FIG. 10, when the test procedure of the method m₂ is displayed on the display device 106, the test procedure of the method m₂ is illustrated on the left side of the screen D2. In addition, an image (screenshot image) G2 of a screen element is illustrated on the right side of the screen D2. In the image G2, a form p21, a link button p23, and the like are illustrated. Here, when the user selects any step of the test procedure using a mouse or the like, an enclosure and the order of the procedure are displayed at a corresponding position on the image G2. For example, in FIG. 10, when the user selects the operation content information “1. Input “yyy””, an enclosure line (an enclosure line by a broken line in FIG. 10) is displayed on the form g21 corresponding thereto, and “1” is also displayed as the test procedure in the method m₂ near the enclosure line.

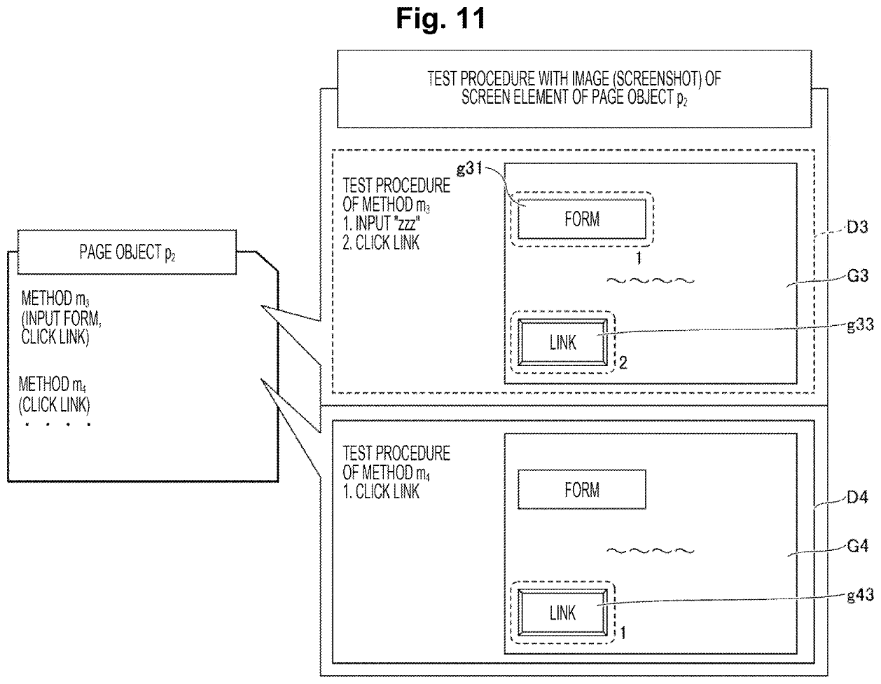

FIG. 11 is a diagram illustrating a concept of information indicating a test procedure with an image (screenshot image) of a screen element operated in the page object p₂.

As illustrated in FIG. 11, when the test procedure of the method m₃ is displayed on the display device 106, each piece of operation content information of the test procedure of the method m₃ is illustrated on the left side of the screen D3. An image (screenshot image) G3 of the screen element is illustrated on the right side of the screen D3. In the image G3, a form g31, a link button g33, and the like are illustrated. Here, when the user selects any step of the test procedure using a mouse or the like, an enclosure and the order of the procedure are displayed at a corresponding position on the image G3. For example, in FIG. 11, when the user selects the operation content information “1. Input “zzz””, an enclosure line (an enclosure line by a broken line in FIG. 11) is displayed on the corresponding input form g31, and “1” is also displayed as the test procedure in the method m₃ near the enclosure line.

On the other hand, as illustrated in FIG. 11, when the test procedure of the method m₄ is displayed on the display device 106, the test procedure of the method m₄ is illustrated on the left side of the screen D4. An image (screenshot image) G4 of a screen element is illustrated on the right side of the screen D4. In the image G4, a link button g43 and the like are illustrated. Here, when the user selects any step of the test procedure using a mouse or the like, an enclosure and the order of the procedure are displayed at a corresponding position on the image G4. For example, in FIG. 11, when the user selects the operation content information “1. Click link”, an enclosure line (an enclosure line by a broken line in FIG. 11) is displayed on the link button g43 corresponding thereto, and “1” is also displayed as the test procedure in the method m₄ near the enclosure line.

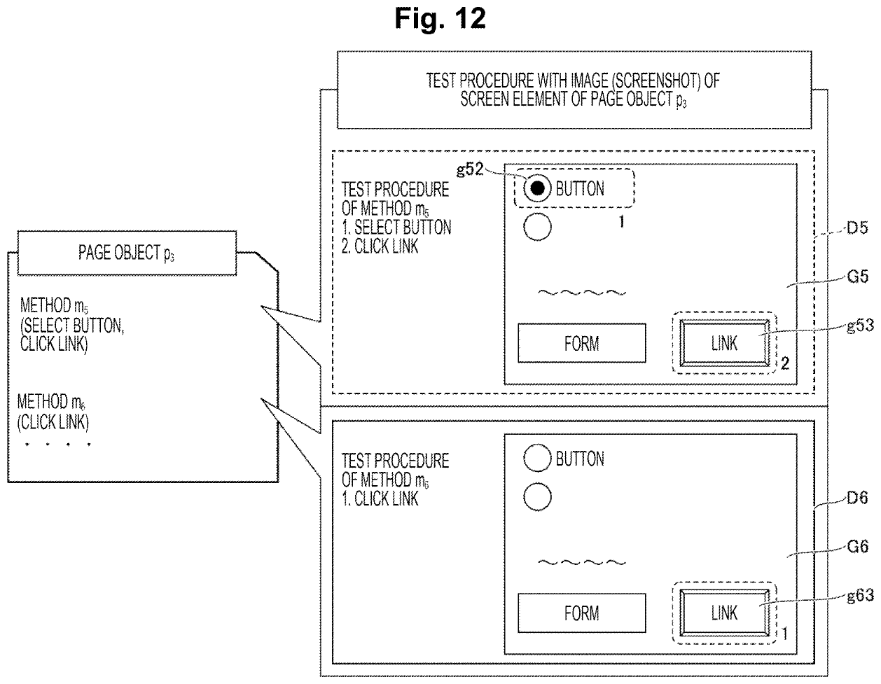

FIG. 12 is a diagram illustrating a concept of information indicating a test procedure with an image (screenshot image) of a screen element operated in the page object p₃.

As illustrated in FIG. 12, when the test procedure of the method m₅ is displayed on the display device 106, each piece of operation content information of the method m₅ test procedure is illustrated on the left side of the screen D5. An image (screenshot image) G5 of a screen element is illustrated on the right side of the screen D5. In the image G5, a radio button g52, a link button g53, and the like are illustrated. Here, when the user selects any step of the test procedure using a mouse or the like, an enclosure and the order of the procedure are displayed at a corresponding position on the image G5. For example, in FIG. 12, when the user selects the operation content information “1. Select button”, an enclosure line (a broken line in FIG. 12) is displayed on the corresponding radio button g52, and “1” is also displayed near the enclosure line as the test procedure in the method m₅.

On the other hand, as illustrated in FIG. 12, when the test procedure of the method me is displayed on the display device 106, the test procedure of the method me is illustrated on the left side of the screen D6. An image (screenshot image) G6 of a screen element is illustrated on the right side of the screen D6. In the image G6, a link button g63 and the like are illustrated. Here, when the user selects any step of the test procedure using a mouse or the like, an enclosure and the order of the procedure are displayed at a corresponding position on the image G6. For example, in FIG. 12, when the user selects the operation content information “1. Click link”, an enclosure line (an enclosure line by a broken line in FIG. 11) is displayed on the link button g63 corresponding thereto, and “1” is also displayed as the test procedure in the method me near the enclosure line.

As described above, for example, as a test procedure of the method m₁, specifically, operation content information indicating that there is an input to a form first, a selection of a button second, and a click of a link third is displayed. Accordingly, the user can more easily grasp the test procedure as compared with a case where the test procedure is automatically named based on the attribute value (id, name, text, etc.) on the source code (HTML or the like).

By performing the screen transitions in FIGS. 10 to 12 for each method mₖ, the user can more easily grasp the procedure of the entire test.

### Main Advantageous Effects of Embodiment

As described above, according to the embodiment, since the operation content information is specifically displayed in the manual of the test script, it is possible to more easily grasp the execution content of the software test as compared with the related art.

As illustrated in FIGS. 7 to 12, the screen transition according to the operation log of the user is displayed in the manual of the test script, so that the user can more easily grasp the procedure of the entire test.

### Supplement

The present invention is not limited to the above-described embodiment and may be configured or processed (operated), as will be described below.

For example, a plurality of CPUs 104 may be used instead of a single CPU.

The above-described highlight display (thick line displayed in FIG. 9) and the above-described enclosure line (an enclosure line by broken line in FIGS. 10 to 12) are examples of changes in the display mode. The changes in the display modes in this case include monochrome inversion display, display for increasing the size, display for changing the color, and display for blinking.

### REFERENCE SIGNS LIST

10 Test device
11 Log information acquisition unit
12 Test script generation unit (example of first generation means)
13 Test script manual generation unit (example of second generation means)
14 Output unit
121 Log information analysis unit
122 Test case generation unit
123 Page object generation unit
131 Screen transition diagram generation unit
132 Test procedure information generation unit

1. A test apparatus comprising:
circuitry configured to
acquire log information according to a first user operation;
generate, for each screen of a target page of a software test, a page object defining one or more methods, based on the log information, each of the methods indicating a test procedure and a second user operation for an operation target that is to be performed on the screen of the target page:
generate, based on the methods defined by the page object, a manual of the software test, the manual including (i) operation content information indicating a content of the second user operation, (ii) the test procedure, and (iii) an image indicating the screen of the target page, the image being used for identifying the operation target as the second user operation; and
output data of the manual.

2. The test apparatus according to claim 1, wherein, upon occurrence of a condition in which predetermined operation content information is selected from of operation content information, the circuitry is configured to change a display type of a predetermined operation target in the image indicating the screen of the target page that corresponds to the predetermined operation content information.

3. The test apparatus according to claim 1, wherein the circuitry is configured to
perform screen transition for a predetermined page as a starting point by using the methods defined by page objects, to generate a test case indicating a route to a last target page, and generate an image indicating screens of the target pages, and the manual of the software test, based on the route in the test case.

4. The test apparatus according to claim 3, wherein the circuitry is configured to generate a screen transition diagram indicating the screen transition for the target pages based on the route in the test case, and generate the manual of the software test based on the screen transition diagram.

5. The test apparatus according to claim 4, wherein the circuitry is configured to integrate screen transition diagrams for test cases to generate a single screen transition diagram.

6. The test apparatus according to claim 5, wherein the circuitry is configured to change a display type of a method related to a predetermined page object.

7. A test method executed by a test apparatus that performs a software test, the test method comprising:
acquiring log information according to a first user operation;
generating, for each screen of a target page of the software test, a page object defining one or more methods, based on the log information, each of the methods indicating a test procedure and a second user operation for an operation target that is to be performed on the screen of the target page;
generating, based on the methods defined by the page object, a manual of the software test, the manual including (i) operation content information indicating a content of the second user operation, (ii) the test procedure, and (iii) an image indicating the screen of the target page, the image being used for identifying the operation target as the second user operation; and
outputting data of the manual.

8. A non-transitory computer readable storage medium storing a program that causes a computer to execute the test method of claim 7.
